(19) United States
(12) Patent Application Publication
(10) Pub. No.: US 2014/0246271 A1
(43) Pub. Date: Sep. 4, 2014

(54) EXTENSION LADDER INCORPORATING A WINCH-OPERATED ELEVATOR

(71) Applicants: Paul Morris Davies, Provo, UT (US); Michael David Cook, Spanish Fork, UT (US)

(72) Inventors: Paul Morris Davies, Provo, UT (US); Michael David Cook, Spanish Fork, UT (US)

(21) Appl. No.: 14/178,271

(22) Filed: Feb. 11, 2014

Related U.S. Application Data
(60) Provisional application No. 61/850,243, filed on Feb. 11, 2013.

(51) Int. Cl. E06C 7/16; E06C 1/393; E06C 1/12; E06C 7/12; E06C 7/42; E06C 7/48

(52) U.S. Cl. CPC E06C 7/16; E06C 7/423; E06C 7/48; E06C 1/12; E06C 7/12; E06C 1/393
USPC 182/103

(57) ABSTRACT

A conventional extension ladder modified to incorporate a foldable-platform-equipped trolley that can be raised and lowered with an electrically-powered winch. An open-channel guide rail is secured to each side of each section of the extension ladder, the guide rails extending the entire length of each section. Each side of the trolley is equipped with upper and lower sets of rotatable guide wheels. Each set comprises three guide wheels in stacked alignment. The trolley always runs on at least one pair of guide rails on opposite sides of the ladder, and may be running on both pairs of guide rails when it is positioned in the region of ladder section overlap. The trolley is equipped with upright posts to which a hand rail is secured. Extendable standards on the ladder base provide additional stability, and a pair of large wheels enhance ladder mobility.

### FIELD OF THE INVENTION

The present invention relates, generally, to electrically-powered man-lift devices and, more particularly, to extension ladders which incorporate an electric-winch-operated elevator.

### BACKGROUND OF THE INVENTION

Powered, ladder-based elevators and hoists are well known in the art. The following list of U.S. Patents is not intended to be an exhaustive list of such devices, but rather a representative disclosure of the relevant prior art. U.S. Pat. No. 2,394,148, issued to Harry L. Campbell on Feb. 5, 1946, discloses a hoist attachment for ladders which provides a conveying and elevating carrier attachment having guide wheels that travel between and over the various sections of an extension ladder.

U.S. Pat. No. 3,115,211, issued to John A. Ostrander, Jr. on Dec. 24, 1963, discloses a ladder hoist which may be readily removably secured to conventional types of ladders, is operated by a motorized and reversible winch assembly, and which can be raised and lowered by the use of simple electrical control switches.

U.S. Pat. No. 3,428,145, issued to Harry C. Lyon on Feb. 18, 1969, discloses a removable, self-powered elevator that attaches to extension or fixed section ladders, and that adapts to tapered or uniform width ladders, and includes a control which can be operated while standing on the elevator or removed for remote control.

U.S. Pat. No. 4,183,423, issued to James P. Lewis on Jan. 15, 1980, discloses a movable cart, bolted to a short bottom section of a ladder, that carries a winch. A cable on the winch runs over a pulley on a short top section of the ladder and is connected to a carriage having wheels running in channel-like side members of the ladder. The carriage has an adjustable, folding platform and a back which pivots to a horizontal position when the carriage reaches the top of the ladder. A bottom pushbutton control and a top pushbutton control are provided.

U.S. Pat. No. 6,244,381 B1, issued to Timothy E. Ruble on Jun. 12, 2001, discloses a ladder hoist device for hoisting material up an extension ladder. The ladder hoist device includes a device that is able to move materials up and down an extension ladder. The device has a back plate with a front side, a back side, a top edge and a bottom edge. A support plate, having an edge fixedly coupled to the front side of the back plate, supports materials to be lifted. A mounting frame has a plurality of rollers for guiding the back plate along the rails of the ladder. A plurality of brackets rotatably couple the rollers to the back plate. Each of the brackets is coupled to each other and to the back plate. The rollers engage the ladder. A pulley system pulls the back plate up the ladder.

U.S. Pat. No. 6,371,449 B1, issued to Bruce T. Chamberlain on Apr. 16, 2002, discloses a portable motorcycle hoist having a main frame assembly which includes a pair of vertically-oriented, parallel channel beams. The channel beams, which are rigidly affixed to an upper cross brace and to a base m ember, provide a caged track for a trolley that is movably slidable, with an electrically-powered winch, between a lowermost position and an uppermost position. A cradle assembly, adapted to support a motorcycle, is rigidly secured to the trolley.

U.S. Pat. No. 7,004,288, issued to Toshiyuki Araki, et al. On Feb. 28, 2006, discloses a lift apparatus for use with a ladder having two spaced upright stringers and a plurality of horizontal rungs bridging the stringers and vertically spaced apart from one another. The lift apparatus comprises a frame, a platform secured to the frame for supporting an operator thereon, a prime mover mounted on the frame and having a rotatable output shaft, at least one pair of sprocket systems vertically spaced apart from one another. At least one of the sprocket systems is operatively coupled with the output shaft of the prime mover. An endless driving force transmitting mechanism can pass around the pair of the sprocket systems. A controller is provided for controlling the prime mover in such a manner as to selectively rotate the output shaft thereof in forward or reverse direction, or stop it.

U.S. Pat. No. 7,546,902 B2, issued to Larry Victor Schwertner, discloses a personnel lift apparatus for raising or lowering a standing person between two or more elevations or from a base elevation to a raised elevation. A moveable lift platform rides within a track provided on a pair of substantially upright side rails. The platform is connected by a flexible metallic cable to an electrically operated winch. The personnel lift eliminates steps and ladders on recreational vehicles on or on any other equipment that requiring climbing.

The adding of a lift or elevator apparatus to a conventional extension ladder typically adds weight to the structure that can dramatically reduce the useful weight that the ladder can support. In addition, the additional weight can make the combined ladder-elevator unwieldy for a single operator. What is needed is an improved extension ladder-elevator that can be easily handled by a single operator and that does not suffer from reduced useful weight capacity as a result of the combination.

### SUMMARY OF THE INVENTION

The present invention provides a conventional extension ladder that has been modified to incorporate a platform-equipped trolley, or bogie, that can be raised and lowered with an electrically-powered winch. A solid aluminum alloy extender rod is inserted through each rung of the extension ladder. A reinforcement plate is slipped over each end of each extender rod and is welded to both the ladder rail and to the extender rod. All extender rods are of equal length, and are positioned so that each extends outwardly from the ladder rail the same distance on both sides. An open-channel guide rail is welded to the ends of the extender tubes on each side of each ladder section of the extension ladder. Thus, a two-section extension ladder utilizes four such guide rails. Each side of the trolley is equipped with upper and lower sets of rotatable guide wheels. Each set comprises three guide wheels in stacked alignment. The first guide wheel, which is nearest the front of the ladder, contacts only the guide rail of the upper section of the extension ladder either in the region of ladder section overlap or above the region of ladder section overlap. The second, or middle, guide wheel, which is approximately centered between the upper and lower sections of the extension ladder, can contact either the guide rail of the upper section exclusively, the guide rail of the lower section exclusively, or both guide rails in regions of ladder section overlap simultaneously. The third guide wheel, which is nearest the back of the ladder, contacts only the guide rail of the lower section of the extension ladder either in the region of ladder section overlap or below the region of ladder section overlap. Thus, the trolley is always running on at least one set of guide rails on opposite side of the ladder, and may be running on both sets of guide rails when it is positioned in the region of ladder section overlap. The trolley is equipped with upright posts. A hand rail is secured to the uppermost ends of the upright posts. A platform for an operator to stand on is secured to the trolley. The platform is equipped with a central hinge that it enables it to be folded in half so that the operator can more easily climb down the ladder in the event of a power or winch motor failure. The base of the ladder is equipped with a pair of retractable standards that can be extended outwardly from each rail in order to provide enhanced stability for the base of the ladder. Each retractable standard is equipped with an adjustable-height, rubber-covered foot that can be raised and lowered with a hand-crank screw. An upper portion of the uppermost section of the extension ladder is equipped with retractable support arms that can be extended outwardly from each rail to enhance stability of the top of the ladder when it is resting against a vertical surface. An electric-motor-driven winch is rigidly affixed near the bottommost rung on the backside of the lower section of the extension ladder. A pulley is affixed to the top rung of the upper section of the extension ladder. A cable, one end of which is secured to the trolley, wraps around the pulley and extends to the winch, where it is attached to the rotatable drum of the winch. Switch controls mounted on or near the handrail of the trolley enable an operator to control the upward or downward travel of the trolley. A pair of vertical-position-assist wheels, installed on an axle that extends between the rails at the top of the upper section of the extension ladder, facilitates the running of the extension ladder up a vertical surface. Large, twenty-inch-diameter transport wheels with pneumatic tires are attached to the trolley. These wheels facilitate transport of the ladder from a carrying vehicle to the work site, and from work site to work site at the same job location. For increased clearance when the ladder is leaned against vertical surfaces, the wheels can be retracted by pulling a retainer pin on the wheel assembly, swinging the wheel assembly forward or backward, and then replacing the retainer pin.

### BRIEF DESCRIPTION OF THE DRAWINGS

FIG. 1 is a side elevational view of the improved extension ladder incorporating a winch-operated elevator, said elevator having an operator standing thereupon;

FIG. 2 is a front elevational view of the improved extension ladder;

FIG. 3 is close-up view of the uppermost end of the improved extension ladder;

FIG. 4 is an isometric view of the uppermost end of the improved extension ladder;

FIG. 5 is a close-up front elevational view of the lowermost end of the improved extension ladder;

FIG. 6 is a perspective drawing produced from a digital photograph which shows the guide wheel and guide rail arrangement;

FIG. 7 is an isometric view of the improved extension ladder in a generally horizontal position with optional transport wheels installed on the trolley;

FIG. 8 is a perspective drawing produced from a digital photograph of a portion of the improved extension ladder, showing the optional transport wheelts, the trolley, and the foldable platform of the trolley; and

FIG. 9 is a perspective drawing produced from a digital photograph of the lower portion of the improved extension ladder, showing the retractable standards, the screw cranks, and the winch and cable.

### PREFERRED EMBODIMENT OF THE INVENTION

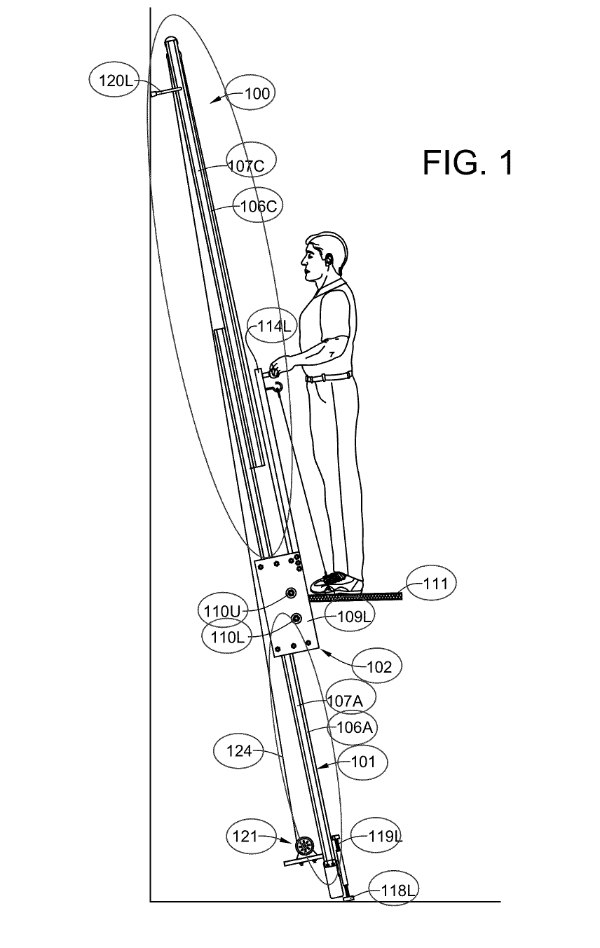

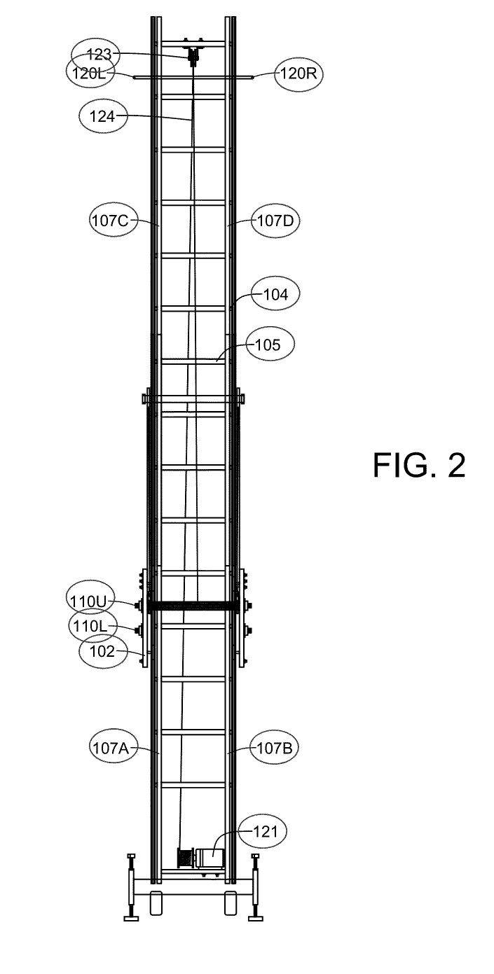

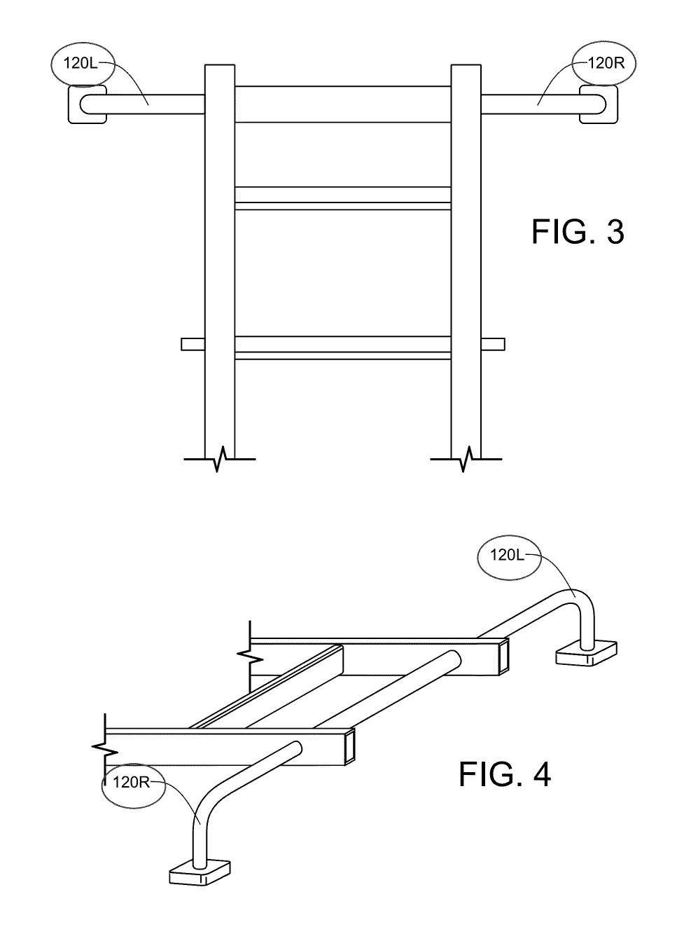

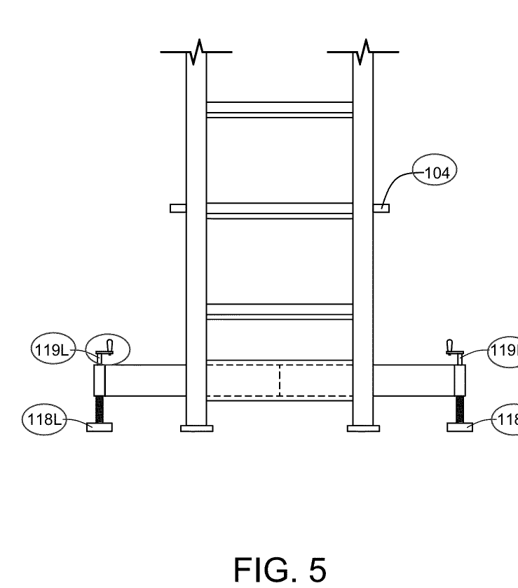

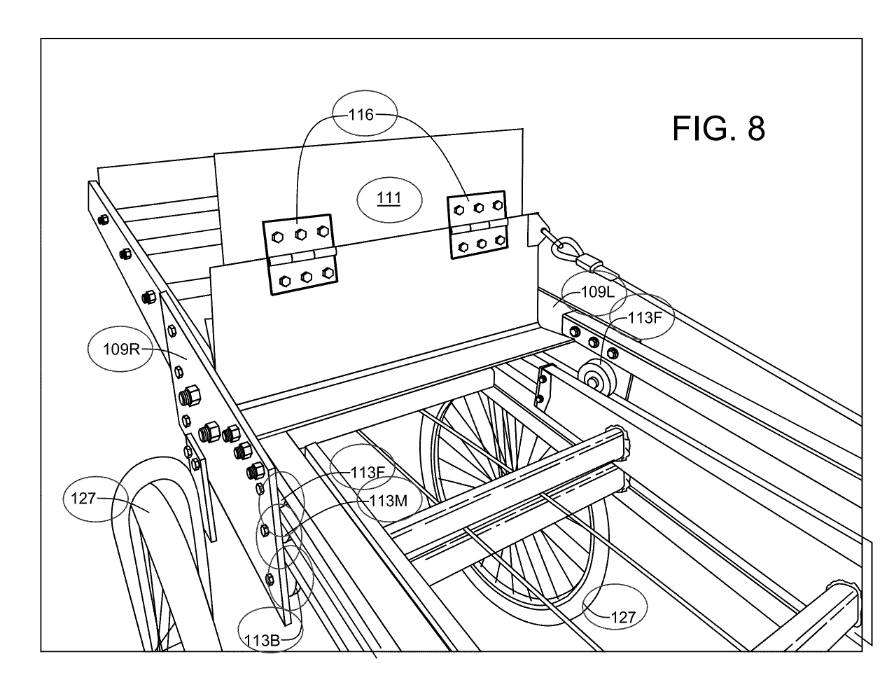

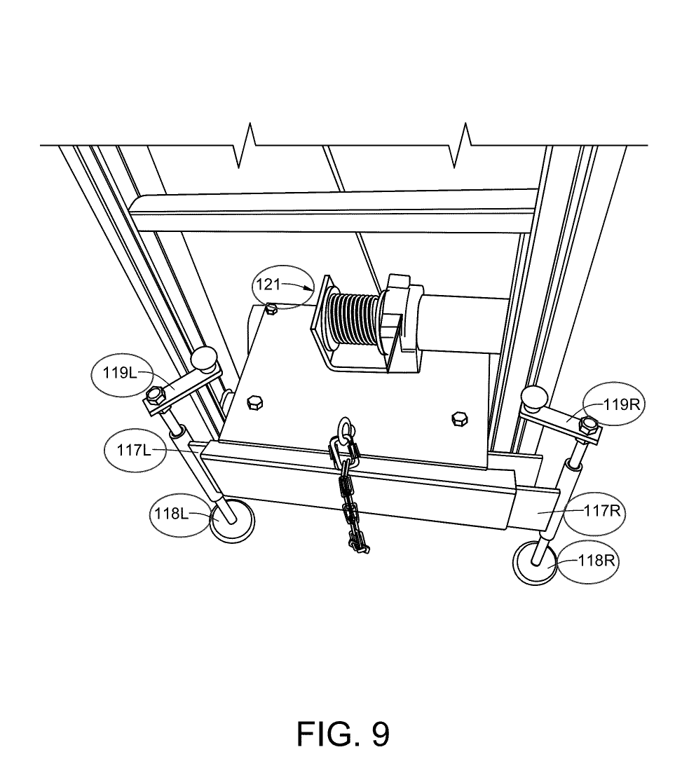

The improved extension ladder incorporating a winch-operated elevator 100 will now be described with reference to drawing FIGS. 1 to 9.

This application incorporates U.S. Provisional Patent Application No. 61/850,243 filed Feb. 11, 2013 in its entirety.

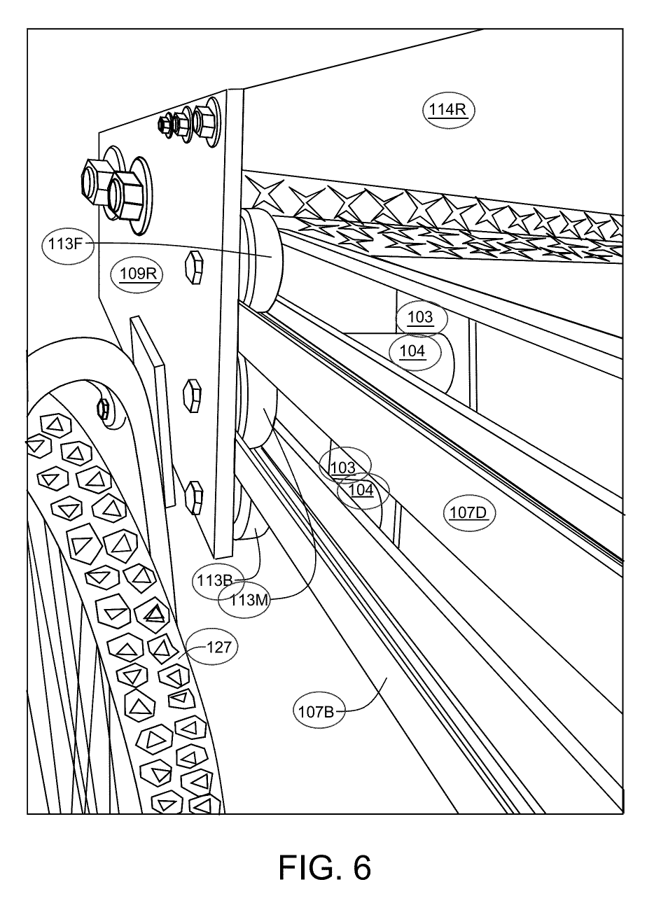

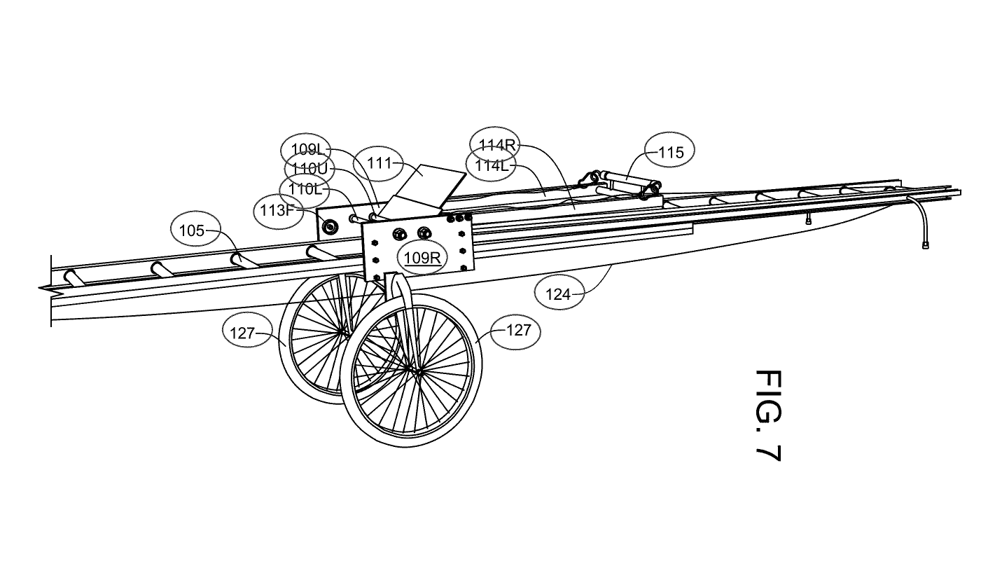

Referring now to FIGS. 1 to 9, the present invention provides a conventional extension ladder 101 that has been modified to incorporate a platform-equipped trolley 102, that can be raised and lowered with an electrically-powered winch 121. A solid aluminum extender rod 104 is inserted through each rung 105 of the extension ladder. A reinforcement plate 103 is slipped over each end of each extender rod 104 and is welded to both the ladder rail 106 and to the extender rod 104 (see FIG. 6). This construction reinforces the rungs so that they can support far more weight than the original ladder. All extender rods 104 are of equal length, and are positioned so that each extends outwardly from the ladder rails 106 the same distance on both sides. An open-channel guide rail 107, generally, is welded to the ends of the extender tubes on each side of each ladder section of the extension ladder. Thus, a two-section extension ladder utilizes four such guide rails: 107A, 107B, 107C and 107D. Guide rails 107A and 107B are secured—via the extender rods 104—to the ladder rails 106A and 106B of lower ladder section 108L, while guide rails 107C and 107D are secured—also via the extender rods 104—to the rails 106C and 106D of upper ladder section 108U. The trolley 102 has a pair of parallel side plates 109L and 109R which are interconnected by upper and lower threaded shafts 110U and 110L, a foldable platform 111 for support of an operator that enables the operator to m ore easily climb down the ladder in the event of a power or motor failure. The foldable platform 111 is anchored to the trolley by the upper threaded shaft 110U. Two sets of three guide wheels 112 are rotatably secured to the inner surface of each side plate in stacked alignment. Thus there are four sets of guide wheels in all 112A, 112B, 112C and 112D. At least two guide wheels from each set are in rolling contact with at least one guide rail. However, when the trolley is positioned in a region of ladder section overlap, three guide wheels 113 of a set can be in rolling contact with two guide rails 107. The first guide wheel 113F of each set on the left side of the trolley 102, which is nearest the front of the ladder, contacts only the guide rail 107C of the upper section 108U of the extension ladder 101 either in the region of ladder section overlap or above the region of ladder section overlap. Likewise, the first guide wheel of each set on the right side of the trolley 102, which is nearest the front of the ladder, contacts only guide rail 107D. The second, or middle, guide wheel 113M of each set on the left side of the trolley 102, which is approximately centered between the upper and lower sections of the extension ladder, can contact either the guide rail 107C of the upper section exclusively, the guide rail 107A of the lower section, or both guide rails 107C and 107A, simultaneously, exclusively, or both guide rails 107A/107C or 107B/107D in regions of ladder section overlap. Likewise, the second, or middle, guide wheel of each set on the right side of the trolley 102, which is approximately centered between the upper and lower sections of the extension ladder, can contact either the guide rail 107D of the upper section exclusively, the guide rail 107B of the lower section, or both guide rails 107D and 107B, simultaneously, in regions of ladder section overlap. The third guide wheel 113B of each set on the right side of the trolley 102, which are nearest the back of the ladder, contact only the guide rail 107A of the lower section 108L of the extension ladder 101 either in the region of ladder section overlap or below the region of ladder section overlap. Likewise, the third guide wheel of each set on the left side of the trolley 102, which are nearest the back of the ladder, contact only the guide rail 107B of the lower section 108L of the extension ladder 101 either in the region of ladder section overlap or below the region of ladder section overlap. Thus, the trolley 102 is always running on at least one set of guide rails on opposite side of the ladder, and may be running on both sets of guide rails when it is positioned in the region of ladder section overlap. The trolley is equipped with upright posts 114L and 114R. A hand rail 115 is secured to the uppermost ends of the upright posts 114L and 114R. The platform 111 is equipped with a central hinge 116 that it enables it to be folded in half so that the operator can more easily climb down the ladder in the event of a power or winch motor failure. The base of the ladder is equipped with a pair of retractable standards 117L and 117R that can be extended outwardly from each rail in order to provide enhanced stability for the base of the ladder. Each retractable standard is equipped with an adjustable-height, rubber-covered foot 118L and 118R that can be raised and lowered with a hand-crank screw 119L and 119R. An upper portion of the uppermost section of the extension ladder is equipped with retractable support arms 120L and 120R that can be extended outwardly from each rail to enhance stability of the top of the ladder when it is resting against a vertical surface. An electric-motor-driven winch 121 is rigidly affixed near the bottommost rung 122 on the backside of the lower section of the extension ladder 101. A pulley 123 is affixed to the top rung of the upper section 109U of the extension ladder 101. A cable 124, one end of which is secured to the trolley 102, wraps around the pulley 123 and extends to the winch 121, where it is attached to the rotatable drum of the winch. Switch controls (not shown) mounted on or near the handrail of the trolley enable an operator to control the upward or downward travel of the trolley. A pair of vertical-position-assist wheels 125L and 125R, installed on an axle 126 that extends between the rails 106C and 106D at the top of the upper section of the extension ladder, facilitates the running of the extension ladder up a vertical surface. Large, twenty-inch-diameter transport wheels 127 with pneumatic tires 128 are attached to the trolley 102. These wheels facilitate transport of the ladder 100 from a carrying vehicle to the work site, and from work site to work site at the same job location. For increased clearance when the ladder is leaned against vertical surfaces, the wheels 127 can be retracted by pulling a retainer pin on the wheel assembly, swinging the wheel assembly forward or backward, and then replacing the retainer pin.

Although only a single embodiment of the improved extension ladder incorporating a winch-operated elevator has been shown and described, it will be obvious to those having ordinary skill in the art that changes and modifications may be made thereto without departing from the scope and the spirit of the invention as hereinafter claimed.

What is claimed is:

1. An improved extension ladder incorporating a winch-operated elevator comprising:
an two-section extension ladder, each section having a pair of parallel rails interconnected by a plurality of rungs;
an open-channel guide rail is secured to an outer side of each rail of each section of the extension ladder, each guide rail extending a major portion of an entire length of each section;
a trolley having a framework, a foldable platform for support of an operator, and parallel side plates having inner surfaces facing the guide the guide rails;
two sets of guide wheels rotatably secured to the inner surface of each side plate, each set comprising three guide wheels in stacked alignment, said trolley always travels on at least one pair of guide rails on opposite sides of the ladder, said trolley traveling on both pairs of guide rails when it is positioned in the region of ladder section overlap;
a pulley secured to an uppermost rung of an upper section of said extension ladder;
an electric-motor-powered winch secured to a bottom portion of a lowermost ladder section;
a cable having a first end secured to said trolley, said cable being wrapped over said pulley and having a second end thereof secured to a rotatable drum of said winch, said winch lifts.

2. The improved extension ladder of claim 1, which further comprises a pair of wheels rotatably secured to said trolley, said wheels facilitating transport of the ladder from a carrying vehicle to a work site, and from one work site to another work site at a same job location.

3. The improved extension ladder of claim 1, which further comprises a pair of opposed retractable standards installed within a base portion of a lower section of said extension ladder, said retractable standards being outwardly extendable from each rail in order to provide enhanced stability for the base of the ladder.

4. The improved extension ladder of claim 3, wherein each retractable standard is equipped with an adjustable-height, rubber-covered foot that can be raised and lowered with a hand-crank screw.

5. The improved extension ladder of claim 1, which further comprises opposed, retractable support arms installed in an upper portion of an upper section of the extension ladder, said retractable support arms being outwardly extendable from each rail to enhance stability of a top portion of the extension ladder when it is resting against a vertical surface.
